(19) United States
(12) Patent Application Publication
(10) Pub. No.: US 2013/0080154 A1
(43) Pub. Date: Mar. 28, 2013

(54) NETWORK BASED RESTORATIVE JUSTICE

(71) Applicant: Katie Cargill, Boulder, CO (US)

(72) Inventor: Katie Cargill, Boulder, CO (US)

(21) Appl. No.: 13/628,585

(22) Filed: Sep. 27, 2012

Related U.S. Application Data
(60) Provisional application No. 61/626,528, filed on Sep. 28, 2011.

(51) Int. Cl. G06F 17/27; G10L 15/26

(52) U.S. Cl. 704/9

(57) ABSTRACT

Systems and methods herein provide for resolution between at least two parties through a network. In one embodiment, a system includes an interface operable to communicatively couple to the network. The system also includes a processor operable to establish secure communications between at least two client terminals and a facilitator terminal through the network. The processor provides dialog interfaces to the client terminals and to the facilitator terminal, receives dialog of the parties from the client terminals via their respective dialog interfaces, and provides the dialog of the parties to the facilitator terminal. The processor receives dialog from the facilitator terminal via the facilitator's dialog interface to manage the dialog between the parties, generates a file detailing an agreement between the parties based on the dialog between the parties, transfers the file to the parties via their respective dialog interfaces, and stores the file for subsequent access by the parties.

### CROSS-REFERENCE RELATED APPLICATIONS

This patent application is a non-provisional patent application that depends from, and therefore benefits from the earlier effective filing date of, U.S. Provisional Patent Application No. 61/626,528 (filed Sep. 28, 2011), the entire contents of which are hereby incorporated.

### FIELD OF THE INVENTION

The field of the invention relates to restorative justice and providing a means for delivering such via network based communications.

### BACKGROUND

Restorative justice (also called reparative justice) is an approach to justice that focuses on the needs of victims, offenders, and the involved community, instead of punishing offenders to satisfy legal principles. Restorative justice is based on a theory of justice that considers crime and wrongdoing to be an offense against an individual or community, rather than the state. Victims take an active role in the process, while offenders are encouraged to take responsibility for their actions, to repair the harm they have done (e.g., by apologizing, returning stolen money, performing community service, etc). Restorative justice also focuses on the personal needs of the victims and offenders and provides help for the offender in order to avoid future offences. Restorative justice that fosters dialogue between victim and offender has shown the highest rates of victim satisfaction and offender accountability.

Restorative practices were traditionally facilitated by trained facilitators. Their specific roles varied based on the type of practice being used and the nature of the conflict or concern. The benefits of an in-person approach are significant, especially from the perspective of advocates and service-providers. Well-trained facilitators can pick up on subtle cues, both verbally and nonverbally, which serve as indicators of needs and opportunities for resolution. However, inconsistency in its application undoubtedly results in some people being treated differently than others for the same offenses, creating resentment, fear, and mistrust. Additionally, restorative justice is often a long process that does not timely meet the needs of individuals in certain environments, such as schools. As a result, many organizations find themselves a sort of hybrid system which is based in a framework of punitive responses, with a goal of incorporating certain restorative options and features.

### SUMMARY

Systems and methods presented herein provide for resolution between at least two parties through a network. For example, the system may be configured with a processor that provides for secure communications over the Internet between the parties while also allowing for interaction from a facilitator such that a resolution to some form of dispute between the parties can be achieved. Once an agreement has been achieved, the agreement can be stored in a database secured within the confines of the dialogue between the parties and the facilitator. That is, the dialogue between the parties and the facilitator may be blocked from unauthorized external access but maintained for subsequent use by the parties.

In one embodiment, a system includes an interface operable to communicatively couple to the network. The system also includes a processor operable to establish secure communications between at least two client terminals and a facilitator terminal through the network, to provide dialog interfaces to the client terminals and to the facilitator terminal, and to receive dialog of the parties from the client terminals via their respective dialog interfaces. The processor is also operable to provide the dialog of the parties to the facilitator terminal, to receive dialog from the facilitator terminal via the facilitator's dialog interface to manage the dialog between the parties, to generate a file detailing an agreement between the parties based on the dialog between the parties, to transfer the file to the parties via their respective dialog interfaces, and to store the file for subsequent access by the parties.

In one embodiment, the processor is further operable to preclude transfer of at least a portion of the dialogue between the parties based on the dialogue from the facilitator terminal. The processor may include a dialog analyzer operable to analyze the dialog of the parties to automatically provide responses to the parties. For example, the processor may be further operable to receive text of the dialog between the parties from their respective dialog interfaces. The dialog analyzer made us scan text of the dialog via a text sifting algorithm to automatically select a statement for presentation to at least one of the parties. Alternatively or additionally, the processor may receive analog speech of the dialog between the parties from their respective dialog interfaces and to convert the speech to text such that the dialog analyzer may scan the text of the dialog via a text sifting algorithm to automatically select a statement for presentation to at least one of the parties.

The various embodiments disclosed herein may be implemented in a variety of ways as a matter of design choice. For example, the embodiments may take the form of physical machines, computer hardware, software, firmware, or combinations thereof. In another embodiment, a computer readable medium is operable to store software instructions for providing restorative justice processes. These software instructions are configured so as to direct a processor or some other processing system to operate in the manner described above.

Other exemplary embodiments are described below.

### BRIEF DESCRIPTION OF THE DRAWINGS

Some embodiments of the present invention are now described, by way of example only, and with reference to the accompanying drawings. The same reference number represents the same element or the same type of element on all drawings.

FIG. 1 is a block diagram of an exemplary restorative justice system.

FIG. 2 is a flow chart of an exemplary method operable with the restorative justice system.

FIGS. 3-5 are exemplary message diagrams operable with the restorative justice system.

FIG. 6 is a block diagram of the exemplary restorative justice system implemented with mobile devices.

FIG. 7 is a block diagram of an exemplary processing system operable to implement the restorative justice system.

### DETAILED DESCRIPTION OF THE DRAWINGS

The figures and the following description illustrate specific exemplary embodiments of the invention. It will thus be appreciated that those skilled in the art will be able to devise various arrangements that, although not explicitly described or shown herein, embody the principles of the invention and are included within the scope of the invention. Furthermore, any examples described herein are intended to aid in understanding the principles of the invention, and are to be construed as being without limitation to such specifically recited examples and conditions. As a result, the invention is not limited to the specific embodiments or examples described below.

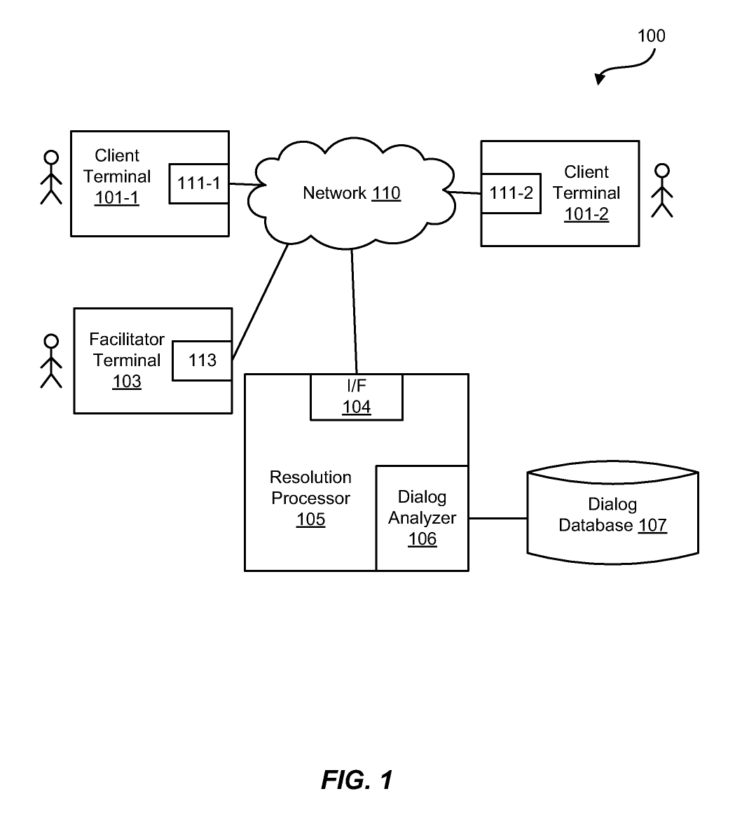

FIG. 1 is a block diagram of an exemplary restorative justice system 100. The restorative justice system 100 includes a resolution processor 105 that is operable to interface (104) with a network 110 to establish a secure link between a plurality of client terminals 101 and a facilitator terminal 103. Once the secure link is established, the resolution processor 105 is operable to maintain dialogue between the client terminals 101 and a facilitator terminal 103 through their respective dialogue interfaces 111 and 113 such that a resolution between parties can be obtained. The network 110 may be any type of network capable of sustaining communications between terminals; one example of such includes the Internet. The resolution processor 105 is therefore any type of system, software, device, or combination thereof that is capable of connecting to the network 110. In one particular embodiment, the resolution processor 105 is configured as an Internet server comprising software operable to implement the communication between the terminals 101-1, 101-2, and 103. The terminals 101-1, 101-2, and 103 can take the form of any type of system, software, device, or combination thereof operable to communicate with the resolution processor 105 via the network 110. Examples of such include mobile computing devices (e.g., cell phones, tablet computers, laptops, and the like) and desktop computing systems.

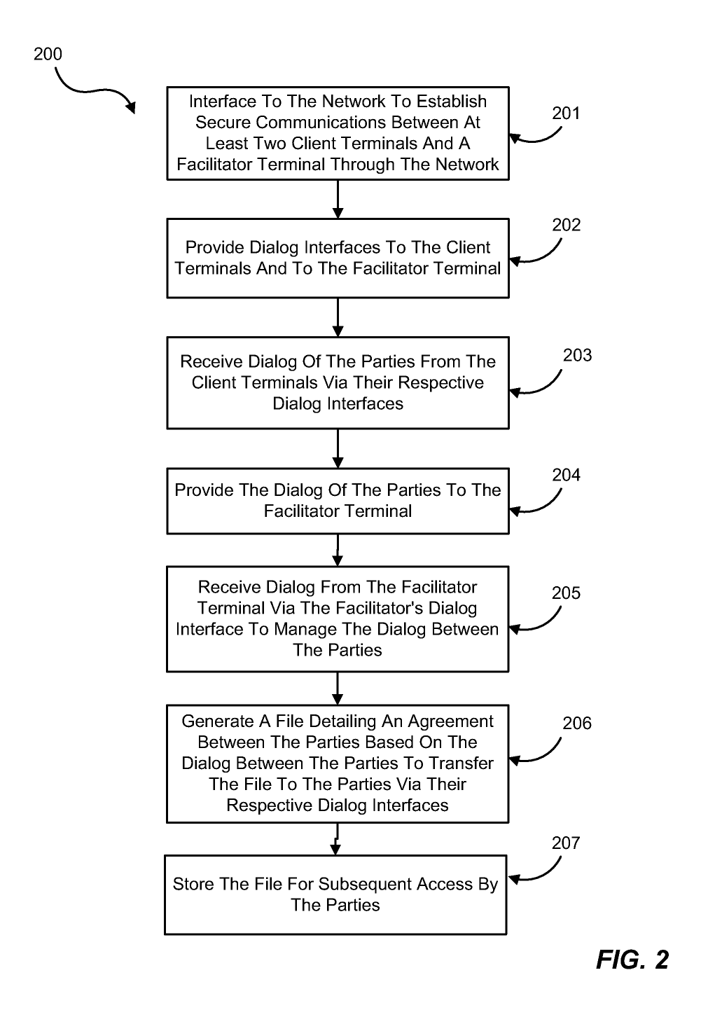

Discussion of the restorative justice system 100 is now made with respect to the method disclosed in FIG. 2. FIG. 2 is a flowchart of the method 200 operable within the resolution processor 105. The method 200 initiates in the process element 201 when the resolution processor 105 interfaces to the network 110 to establish the secure communications between at least two client terminals 101-1 and 101-2 and a facilitator terminal 103. For example, parties having a dispute may establish an account with the resolution processor 105 through their respective client terminals 101-1 and 101-2. Once logged into their accounts, the resolution processor 105 may link the two parties to establish dialogue. In this regard, the resolution processor 105 provides dialogue interfaces 111-1 and 111-2 to the respective client terminals 101-1 and 101-2 so that the dialogue between the two parties may commence, in the process element 202.

The resolution processor 105 may receive dialogue of the parties from the client terminals 101-1 and 101-2 via their respective dialogue interfaces, in the process element 203. Similarly, the resolution processor 105 may provide a dialog interface 113 to the facilitator terminal 103 such that a facilitator may monitor the dialogue of the parties. In this regard, the resolution processor 105 may provide the dialogue of the parties to the facilitator terminal 103, in the process element 204. The dialog interface 113 of the facilitator terminal 103 may allow the facilitator to interact with the dialogue between the parties. For example, in certain situations where the dialogue becomes intense, heated, or otherwise counterproductive, the facilitator may control the direction of the dialogue by entering into the conversation between the parties. Accordingly, this dialogue from the facilitator may be received through the facilitator's dialogue interface 113 to manage the dialogue between the parties, in the process element 205.

After some period of time during the dialogue between the parties, an agreement between the parties may be formed. The resolution processor 105 generates a file detailing the agreement between the parties and transfers the file to the parties via their respective dialogue interfaces 111-1 and 111-2, in the process element 206, so that they may have a written version in their possession. So that the agreement is maintained, the resolution processor 105 stores the file for subsequent access by the parties and/or the facilitator, in the process element 207. For example, to provide evidence that the agreement did indeed come to fruition in case one or more of the parties to the agreement reneges, the parties and/or the facilitator may access the resolution processor 105 to retrieve the agreement file.

It should be noted that, while the resolution processor 105 may be operable to establish a secure session between the client terminals 101-1 and 101-2 such that the parties may have a dialogue at the same time, the invention is not intended to be so limited. The resolution processor 105 may be alternatively or additionally operable to maintain the dialogue between the parties at different times. For example, a first party may communicate through the client terminal 101-1 to the resolution processor 105. The first party may then logout from the resolution processor 105 with the resolution processor 105 maintaining the conversation of the first party in the dialogue database 107 or other storage device. At some time thereafter, the second party may login to the client terminal 101-2 and retrieve the dialogue initiated by the first party. Then, the second party may communicate through the dialogue interface 111-2 in response to the first party's dialogue.

It should also be noted that the invention is not intended to be limited to any particular number of client terminals 101 and facilitator terminals 103. For example, more than two parties may be involved in a particular situation in which restorative justice may be preferable. There may even be more than one facilitator in a situation. The resolution processor 105 is operable to provide as many dialogue interfaces 111 and facilitator interfaces 113 as justified by the situation presented to the resolution processor 105.

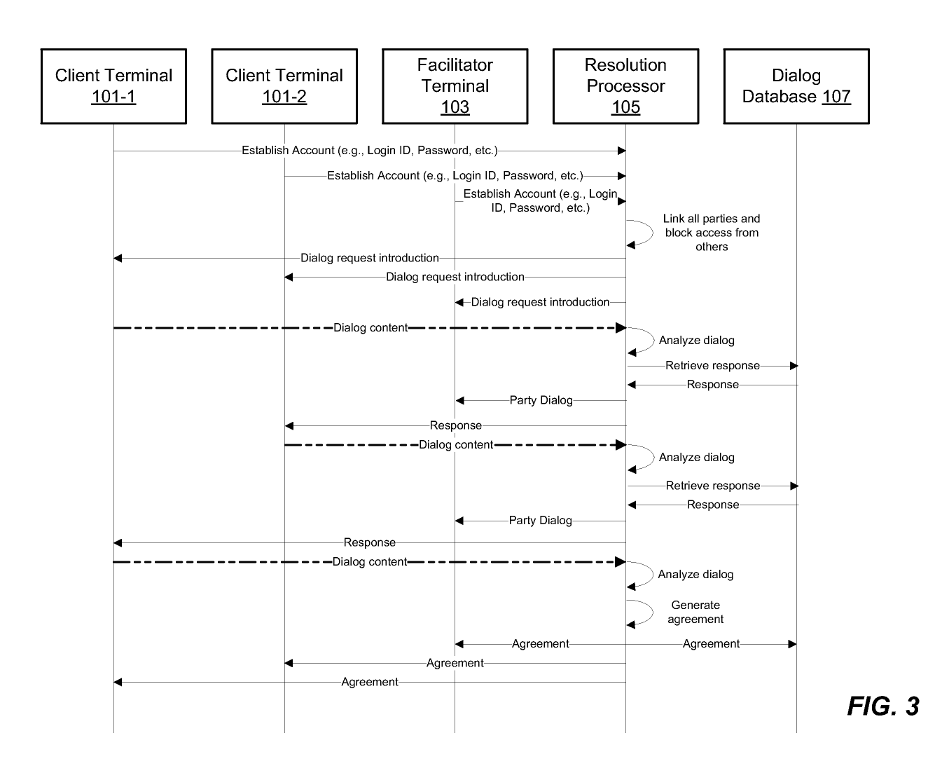

FIGS. 3-5 are exemplary message diagrams operable with the restorative justice system 100. FIG. 3 illustrates a messaging diagram wherein the restorative justice system 100 finds agreement between the parties of the client terminals 101-1 and 101-2. The process starts with the parties establishing accounts with the resolution processor 105. For example, each party through their respective terminals 101 including the facilitator through the facilitator terminal 103 may establish an account with a login ID, password, etc. and provide details of the particular resolution being sought. The resolution processor 105 then links the parties and blocks access from others interacting with the restorative justice system 100. In other words, the resolution processor 105 creates a secure environment in which the parties and the facilitator may seek resolution to their particular situation.

The resolution processor 105 sends dialogue request introductions to each of the client terminals 101 and the facilitator terminal 103 so that the parties may initiate dialogue with one another. Such may include providing an initial survey or questionnaire regarding expectations from the restorative justice process. Thereafter, a first party may send dialogue from the client terminal 101-1 to the resolution processor 105. The resolution processor 105 may in turn analyze the dialogue to automatically retrieve and provide a response to the party of the client terminal 101-1. For example, the resolution processor 105 may be configured with a dialogue analyzer 106 that is operable to scan the text of the dialogue using various text sifting algorithms, such as those found in plagiarism detection. In doing so, the resolution processor 105 may recognize an appropriate response and retrieve that response from the dialogue database 107 for transfer to the client terminal 101-1 as well as to the facilitator terminal 103. To illustrate, the party through the client terminal 101-1 may transfer text that states something as vague as “Bob, I don't know why we can't get along”. The resolution processor 105 may scan the text and identify an appropriate response for the party using the client terminal 101-2. Such a response may include “Bob does not understand why the two of you cannot get along. Perhaps you should ask Bob to provide a little more detail of your dispute”. The resolution processor 105 may then transfer that response to the client terminal 101-2 for the party to respond. The resolution processor 105 may then analyze the incoming text from the client terminal 101-2 in the form of a similar text scanning process to identify an appropriate response for the client terminal 101-1. This process may continue until some agreement can be formed. For example, the first party, through the client terminal 101-1 may convey dialogue to the resolution processor 105 that is analyzed by the resolution processor 105 and found to be an agreement between the two parties. The resolution processor 105 may then generate an agreement for the parties and transfer the agreement to the parties via their respective client terminals 101-1 and 101-2 as well as the facilitator terminal 103. The resolution processor 105 may also store a copy of the agreement in the dialogue database 107 secured within the confines of the dialogue between each of the parties. In other words, the resolution processor 105 may store the agreement for subsequent access by any of the parties in the dialogue process while preventing access to others external to their particular dialogue process.

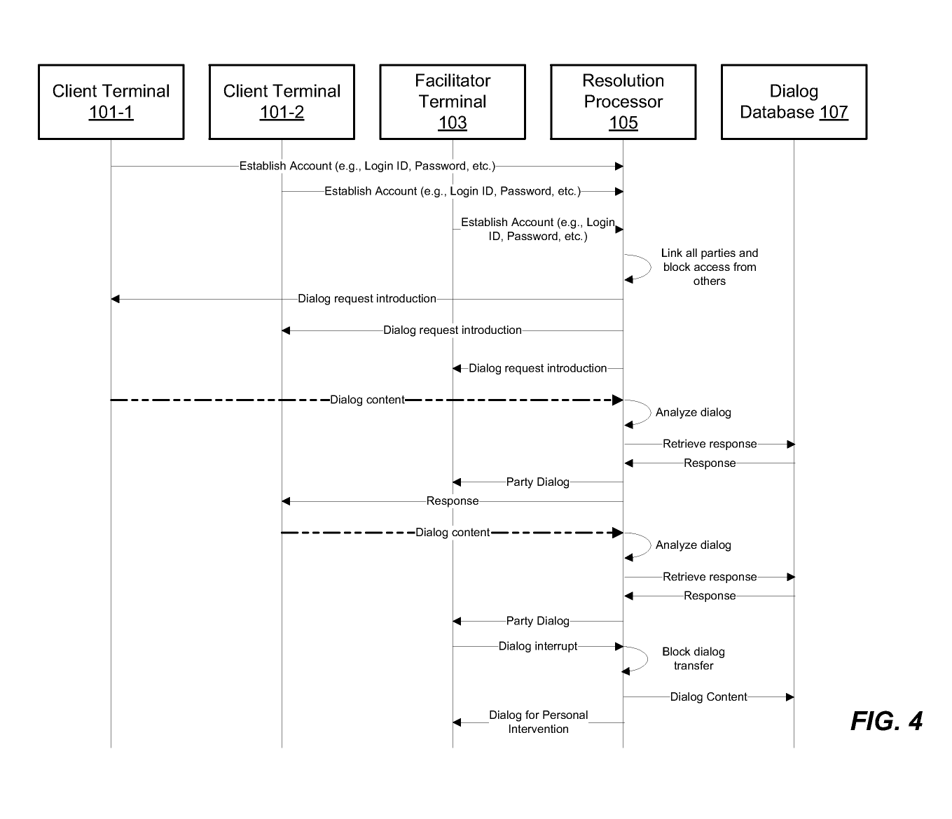

FIG. 4 illustrates a messaging diagram wherein the restorative justice system 100 finds no agreement between the parties of the client terminals 101-1 and 101-2. In fact, in this embodiment, the restorative justice system 100 determines that intervention is necessary. For example, the dialogue process discussed above may continue until the resolution processor 105 receives dialogue from the client terminal 101-2 that is determined to be counterproductive to the restorative justice process. In this embodiment, the resolution processor 105 analyzes the text from the client terminal 101-2 and retrieves an appropriate response but instead transfers the response only to the facilitator terminal 103. Upon review by the facilitator, the resolution processor receives a dialogue interrupt from the facilitator terminal 103 indicating that subsequent dialogue between the parties of the client terminals 101-1 and 101-2 should cease at least temporarily. A record of that dialogue may be stored with the dialogue database 107 and transferred to the facilitator terminal 103 such that a facilitator may intervene between the two parties.

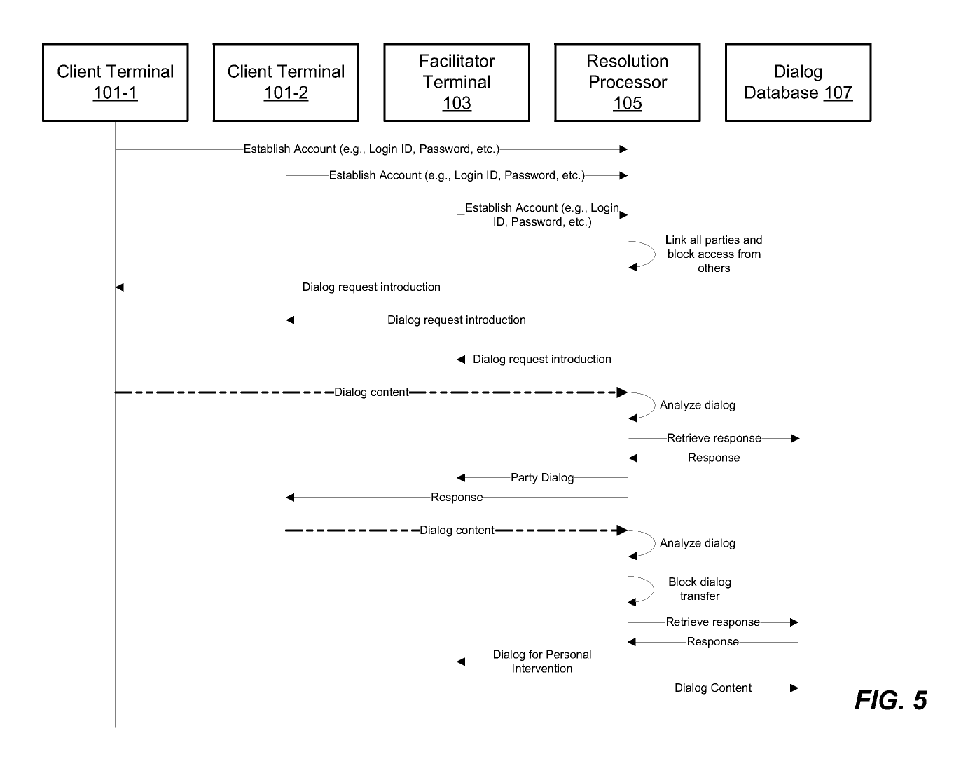

FIG. 5 illustrates another messaging diagram wherein the restorative justice system 100 finds no agreement between the parties of the client terminals 101-1 and 101-2. In this embodiment, the resolution processor 105 analyzes the dialogue from the client terminal 101-1 and determines that the dialogue between the two parties has become counterproductive. The resolution processor 105 may then automatically cease further dialogue between the parties of the client terminals 101-1 and 101-2 and retrieve a response from the dialogue database 107 for review by the facilitator. In other words, upon determining that the session has become counterproductive, the resolution processor 105 may send an automatic response containing the dialogue to the facilitator terminal 103 such that the facilitator may perform a review. The resolution processor 105 may then store the dialogue content with the dialogue database 107 secured in a manner disclosed above.

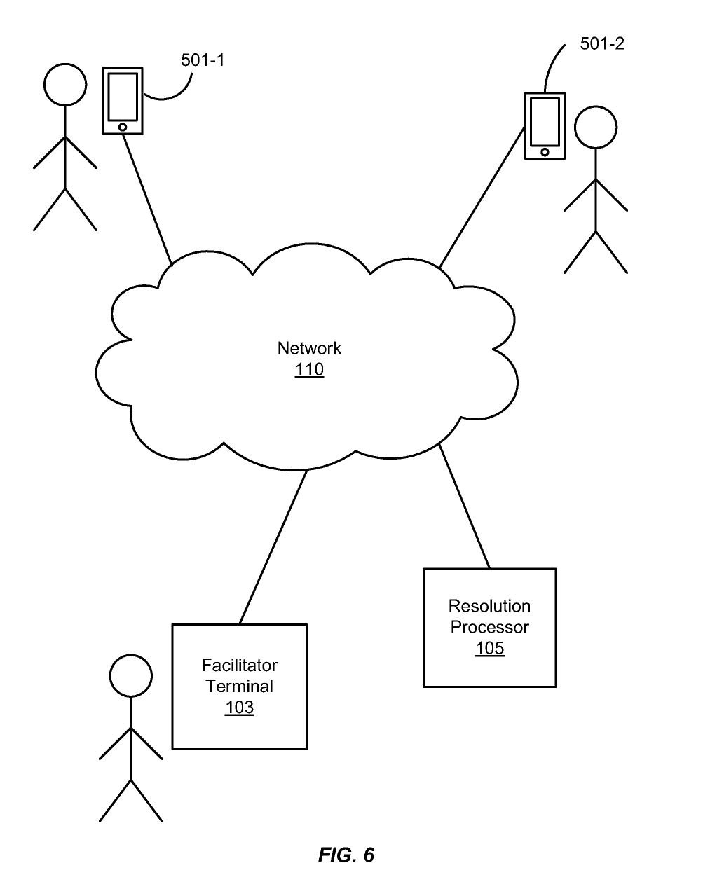

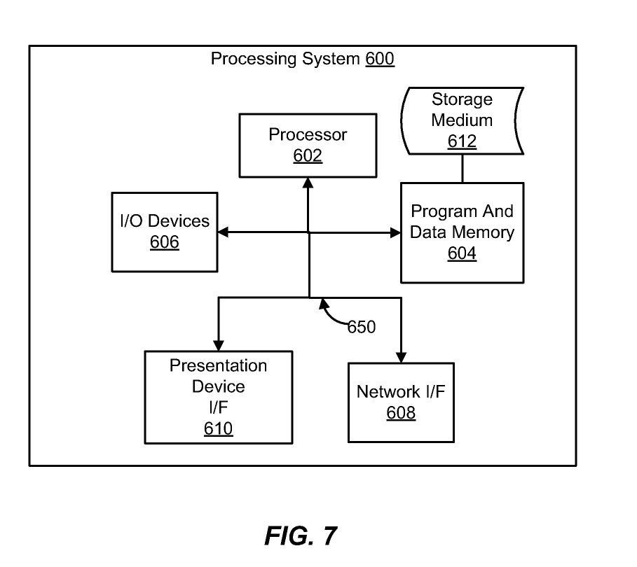

FIG. 6 is a block diagram of the exemplary restorative justice system 100 and implemented with mobile devices 501-1 and 501-2. In this embodiment, the parties to the restorative justice system may interact with one another through their respective mobile devices 501 via a software application operable within the operating system environment of their mobile devices. For example, a first party may download an “app” to a smart phone that is operable to interact with the resolution processor 105 through the network 110. Similarly, the second party may download an app to a smart phone that allows them to interact with the first party in the restorative justice process. Thus, the parties may establish accounts through their respective mobile devices 501 with the resolution processor 105 that allows them to communicate with one another as well as the facilitator terminal 103 in a secure environment that blocks access to unauthorized others.

These apps may allow the parties to communicate via text and/or voice with the resolution processor 105. For example, the app may include voice recognition software that converts analog voice received via the mobile devices 501 to text such that the resolution processor 105 may scan the text and identify appropriate responses as described above. The facilitator terminal 103 may also include voice recognition software that converts analog voice from the facilitator to text for interaction with the resolution processor 105.

FIG. 6 is a block diagram depicting a processing system 600 also operable to provide the above features by executing programmed instructions and accessing data stored on a computer readable storage medium 612. In this regard, embodiments of the invention can take the form of a computer program accessible via the computer-readable medium 612 providing program code for use by a computer or any other instruction execution system. For the purposes of this description, computer readable storage medium 612 can be anything that can contain, store, communicate, or transport the program for use by a computer.

The computer readable storage medium 612 can be an electronic, magnetic, optical, electromagnetic, infrared, or semiconductor device. Examples of computer readable storage medium 612 include a solid state memory, a magnetic tape, a removable computer diskette, a random access memory (RAM), a read-only memory (ROM), a rigid magnetic disk, and an optical disk. Current examples of optical disks include compact disk—read only memory (CD-ROM), compact disk—read/write (CD-R/W), and DVD.

The processing system 600, being suitable for storing and/or executing the program code, includes at least one processor 602 coupled to memory elements 604 through a system bus 650. Memory elements 604 can include local memory employed during actual execution of the program code, bulk storage, and cache memories that provide temporary storage of at least some program code and/or data in order to reduce the number of times the code and/or data are retrieved from bulk storage during execution.

Input/output (I/O) devices 606 (including but not limited to keyboards, displays, pointing devices, etc) can be coupled to the processing system 600 either directly or through intervening I/O controllers. Network adapter interfaces 608 may also be coupled to the system to enable the processing system 600 to become coupled to other processing systems or storage devices through intervening private or public networks. Modems, cable modems, IBM Channel attachments, SCSI, Fibre Channel, and Ethernet cards are just a few of the currently available types of network or host interface adapters. Presentation device interface 610 may be coupled to the system to interface to one or more presentation devices, such as printing systems and displays for presentation of presentation data generated by the processor 602.

While the invention has been illustrated and described in detail in the drawings and foregoing description, such illustration and description is to be considered as exemplary and not restrictive in character. Certain embodiments described hereinabove may be combinable with other described embodiments and/or arranged in other ways. Accordingly, it should be understood that only the preferred embodiment and variants thereof have been shown and described and that all changes and modifications that come within the spirit of the invention are desired to be protected.

What is claimed is:

1. A system operable to provide resolution between at least two parties through a network, the system comprising:
an interface operable to communicatively couple to the network; and
a processor operable to establish secure communications between at least two client terminals and a facilitator terminal through the network, to provide dialog interfaces to the client terminals and to the facilitator terminal, to receive dialog of the parties from the client terminals via their respective dialog interfaces, to provide the dialog of the parties to the facilitator terminal, to receive dialog from the facilitator terminal via the facilitator's dialog interface to manage the dialog between the parties, to generate a file detailing an agreement between the parties based on the dialog between the parties, to transfer the file to the parties via their respective dialog interfaces, and to store the file for subsequent access by the parties.

2. The system of claim 1, wherein:
the processor is further operable to preclude transfer of at least a portion of the dialogue between the parties based on the dialogue from the facilitator terminal.

3. The system of claim 1, wherein:
the processor comprises a dialog analyzer operable to analyze the dialog of the parties to automatically provide responses to the parties.

4. The system of claim 3, wherein:
the processor is further operable to receive text of the dialog between the parties from their respective dialog interfaces; and
the dialog analyzer is further operable to scan the text of the dialog via a text sifting algorithm to automatically select a statement for presentation to at least one of the parties.

5. The system of claim 3, wherein:
the processor is further operable to receive analog speech of the dialog between the parties from their respective dialog interfaces and to convert the speech to text; and
the dialog analyzer is further operable to scan the text of the dialog via a text sifting algorithm to automatically select a statement for presentation to at least one of the parties.

6. A method of providing resolution between at least two parties through a network, the method comprising:
interfacing to the network to establish secure communications between at least two client terminals and a facilitator terminal through the network;
providing dialog interfaces to the client terminals and to the facilitator terminal;
receiving dialog of the parties from the client terminals via their respective dialog interfaces;
providing the dialog of the parties to the facilitator terminal;
receiving dialog from the facilitator terminal via the facilitator's dialog interface to manage the dialog between the parties;
generating a file detailing an agreement between the parties based on the dialog between the parties to transfer the file to the parties via their respective dialog interfaces; and
storing the file for subsequent access by the parties.

7. The method of claim 6, further comprising:
precluding transfer of at least a portion of the dialogue between the parties based on the dialogue from the facilitator terminal.

8. The method of claim 6, further comprising:
analyzing the dialog of the parties to automatically provide responses to the parties.

9. The method of claim 8, further comprising:
receiving text of the dialog between the parties from their respective dialog interfaces; and
scanning the text of the dialog via a text sifting algorithm to automatically select a statement for presentation to at least one of the parties as the provided responses.

10. The method of claim 8, further comprising:
receiving analog speech of the dialog between the parties from their respective dialog interfaces;
converting the speech to text; and
scanning the text of the dialog via a text sifting algorithm to automatically select a statement for presentation to at least one of the parties.

11. A non-transitory computer readable medium comprising instructions that, when executed by a processor, direct the processor to establish resolution dialogue between at least two parties through a network, the instructions further directing the processor to:
interface to the network to establish secure communications between at least two client terminals and a facilitator terminal through the network;
provide dialog interfaces to the client terminals and to the facilitator terminal;
receive dialog of the parties from the client terminals via their respective dialog interfaces;
provide the dialog of the parties to the facilitator terminal;
receive dialog from the facilitator terminal via the facilitator's dialog interface to manage the dialog between the parties;
generate a file detailing an agreement between the parties based on the dialog between the parties to transfer the file to the parties via their respective dialog interfaces; and
store the file for subsequent access by the parties.

12. The computer readable medium of claim 11, further comprising instructions that direct the processor to:
preclude transfer of at least a portion of the dialogue between the parties based on the dialogue from the facilitator terminal.

13. The computer readable medium of claim 11, further comprising instructions that direct the processor to:
analyze the dialog of the parties to automatically provide responses to the parties.

14. The computer readable medium of claim 13, further comprising instructions that direct the processor to:
receive text of the dialog between the parties from their respective dialog interfaces; and
scan the text of the dialog via a text sifting algorithm to automatically select a statement for presentation to at least one of the parties as the provided responses.

15. The computer readable medium of claim 13, further comprising instructions that direct the processor to:
receive analog speech of the dialog between the parties from their respective dialog interfaces;
convert the speech to text; and
scan the text of the dialog via a text sifting algorithm to automatically select a statement for presentation to at least one of the parties.
